(19) United States
(12) Patent Application Publication
(10) Pub. No.: US 2010/0005257 A1
(43) Pub. Date: Jan. 7, 2010

(54) STORAGE DEVICE, CONTROLLING METHOD FOR STORAGE DEVICE, AND CONTROL PROGRAM

(75) Inventors: Masaaki Tamura, Kawasaki (JP); Gen Ohshima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/480,458

(22) Filed: Jun. 8, 2009

(30) Foreign Application Priority Data
Jul. 1, 2008 (JP) 2008-172033

(51) Int. Cl. G06F 12/00; G06F 12/16; G06F 9/44

(52) U.S. Cl. 711/156; 711/161; 711/E12.001; 711/E12.103; 712/225

(57) ABSTRACT

A storage device includes a first storage unit that stores data read from a recording medium based on an instruction received from a processing device, and transmitting the data stored in the first storage unit to the processing device. The storage device also includes a second storage unit that stores the instruction received from the processing device; a counter that counts the number of pieces of data stored in the first storage unit; and a control unit that transmits the data stored in the first storage unit to the processing device based on a count value of the counter and, when the data read upon the instruction is stored in the first storage unit, writes identification information indicating that storing data has been completed in the second storage unit and, based on the identification information, transmits the data stored in the first storage unit to the processing device.

### CROSS-REFERENCE TO RELATED APPLICATION

This application is based upon and claims the benefit of priority of the prior Japanese Patent Application No. 2008-172033, filed on Jul. 1, 2008, the entire contents of which are incorporated herein by reference.

### FIELD

The embodiments discussed herein are directed to a storage device including a first storage unit that stores data read from a recording medium based on an instruction received from a processing device, and transmitting the data stored in the first storage unit to the processing device.

### BACKGROUND

Examples of a data reading method for use in a magnetic disk device, which is a storage device, are explained in the following. In one method, when a read command is received from a processing device as a host, it is determined that requested data has already been stored in a buffer, and requested data stored in the buffer is read and transmitted to the processing device. In another method, when read command is received from the processing device, it is determined that requested data has not been stored in the buffer, and requested data is read from a sector of a recording medium, stored in the buffer, and is then transmitted to the processing device. Here, at the time of data reading, data not request is also read from a sector near the sector in which the requested data is stored, and is stored in the buffer as pre-read data. When the pre-read data is data requested by a new read command, the pre-read data can be immediately read from the buffer, thereby achieving high-speed data processing.

Whether the data read from the recording medium is stored in the buffer is determined based on the value of a counter provided to the magnetic disk device. Every time data read from the recording medium is stored in the buffer, the value of the counter is incremented by a control unit. Every time the data stored in the buffer is transmitted to the processing device, the value of the counter is decremented by the control unit. By referring to the value of the counter, it can be determined whether the data is stored in the buffer. Upon completion of transmission of the data to the processing device, the value of the counter is initialized to 0 (zero). As explained above, since the buffer has the pre-read data also stored therein, the number of pieces of data to be transmitted to the processing device and the number of pieces of data stored in the buffer do not match each other. For this reason, if the control unit decrements the value of the counter every time the requested data is transmitted to the processing device, the value of the counter always indicates the number of pieces of pre-read data stored in the buffer. To get around this, the value of the counter is initialized, thereby preventing the situation in which the value of the counter becomes equal to or larger than 1 and it is erroneously determined that data requested by a new read command has already been stored in the buffer.

Here, when receiving a plurality of read commands from the processing device, during transmission of the data stored in the buffer to the processing device, the magnetic disk device starts a process of reading data corresponding to a new read command. With such a concurrent process, high-speed data processing is achieved. The control unit causes a head to move to a sector where data corresponding to the new read command is stored. If data transmission to the processing device is completed during the head movement, the value of the counter can be initialized. For this reason, the counter can be used in a process of reading data requested by the new read command. However, if data transmission is not completed, the counter cannot be used in a process of reading data requested by the new read command. This is because, if the value of the counter is initialized, it is erroneously determined that the data to be transmitted to the processing device is not stored in the buffer. Thus, waiting for completion of data transmission is required, which delays data transmission to the processing device, thereby making it impossible to achieve high-speed data processing. In one method of reading data corresponding to a new read command while data corresponding to a read command is being transmitted to the processing apparatus, a plurality of counters are provided. However, such addition of counters becomes a cause of increasing the amount of hardware configuration of the magnetic disk device.

An example of technological document regarding conventional technologies is Japanese Laid-open Patent Publication No. 2000-123475.

### SUMMARY

According to an aspect of the invention, a storage device includes a first storage unit that stores data read from a recording medium based on an instruction received from a processing device, and transmitting the data stored in the first storage unit to the processing device. The storage device also includes a second storage unit that stores the instruction received from the processing device; a counter that counts the number of pieces of data stored in the first storage unit; and a control unit that transmits the data stored in the first storage unit to the processing device based on a count value of the counter and, when the data read upon the instruction is stored in the first storage unit, writes identification information indicating that storing data has been completed in the second storage unit and, based on the identification information, transmits the data stored in the first storage unit to the processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of the configuration of a magnetic disk device;

FIG. 2 is a diagram of the configuration of a control unit;

FIG. 3 is a diagram of a command control unit;

FIG. 4 is a first flowchart of the process of a disk control unit;

FIG. 5 is a second flowchart of the process of the disk control unit;

FIG. 6 is a first flowchart of the process of an initiator control unit;

FIG. 7 is a second flowchart of the process of the initiator control unit;

FIG. 8 is a first diagram of a relation between a reading process by the disk control unit and a transmitting process by an initiator control unit; and

FIG. 9 is a second diagram of the relation between the reading process by the disk control unit and the transmitting process by the initiator control unit.

### DESCRIPTION OF EMBODIMENT(S)

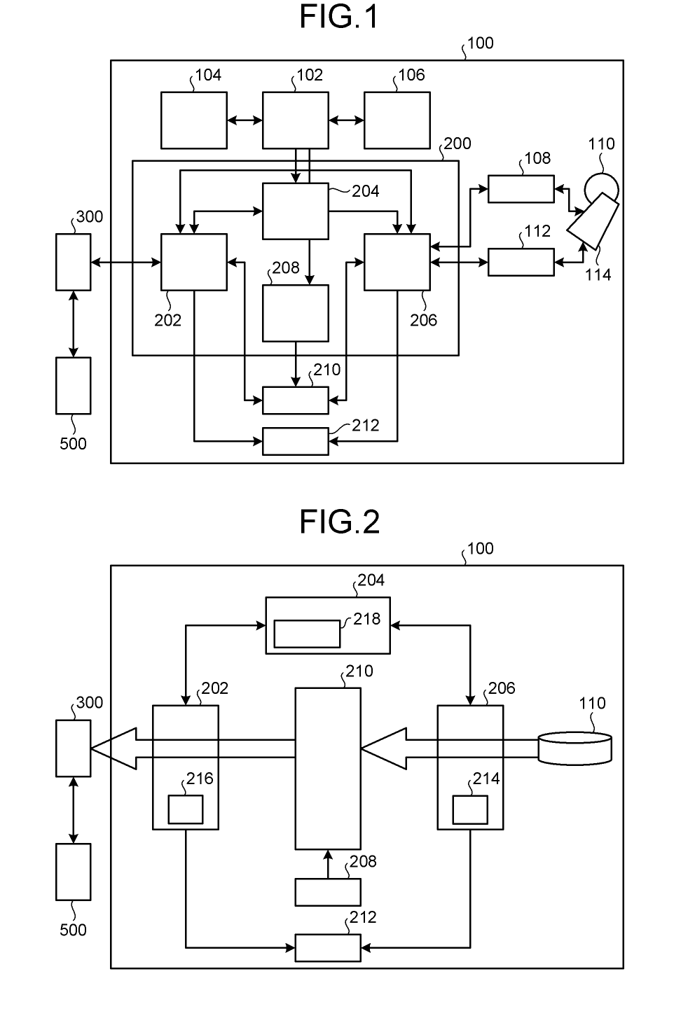

A preferred embodiment of the present invention will be explained with reference to accompanying drawings. FIG. 1 is a diagram of a magnetic disk device 100 in the present embodiment. The magnetic disk device 100 includes a Micro Processing Unit (MPU, microprocessor) 102, a Read Only Memory (ROM) 104, a Random Access Memory (RAM) 106, a control unit 200, a buffer 210, a signal processing unit 108, a magnetic disk 110, a servo control unit 112, and a head actuator 114. Also, the magnetic disk device 100 is connected to an initiator 300 to perform transmission and reception of commands and data with a host 500 as a processing device for processing data.

The MPU 102 controls the magnetic disk device 100 in conjunction with the control unit 200. The ROM 104 has stored therein programs and data to be executed by the MPU 102. On the RAM 106, firmware is developed, which is drive control software including control codes and variables. The firmware is preferably stored as being distributed to, for example, the ROM 104 and the magnetic disk 110. The magnetic disk 110 is mounted on a rotational shaft of a spindle motor. The magnetic disk 110 rotates, for example, at 1000 revolutions per minute. The magnetic disk 110 has data stored therein.

The head actuator 114 has a head mounted at the tip of an arm. On the head, a write head element and a read head element are integrally mounted. As a technique for magnetic recording onto the magnetic disk 110 by the head, either of a longitudinal magnetic recording technique and a vertical magnetic recording technique will suffice. The servo control unit 112 controls the head actuator 114, and aligns the head mounted on the head actuator 114 with respect to the magnetic disk 110. The signal processing unit 108 is connected to the head mounted on the head actuator 114. The signal processing unit 108 receives a read command or a write command from the host 500 as an upper device. The signal processing unit 108 transmits the received write command to the write head element mounted on the head and the received read command to the read head element mounted on the head. The head performs write or read onto or from the magnetic disk 110 upon receiving a command from the signal processing unit 108. Also, the signal processing unit 108 receives data read by the head from the magnetic disk 110.

FIG. 2 is a diagram of a data reading process. The control unit 200 explained with reference to FIG. 1 includes a command control unit 204, a disk control unit 206, an initiator control unit 202, and a buffer control unit 208. The command control unit 204 includes a command information table 218. The command control unit 204 activates the disk control unit 206 and the initiator control unit 202 according to a command transmitted from the host 500 via the initiator 300. The buffer control unit 208 manages a segment of the buffer 210 storing data.

Upon receiving a write command or write data from the host 500 via the initiator 300, the initiator control unit 202 transmits the write command to the MPU 102 and the write data to the buffer 210. The MPU 102 analyzes the write command received from the initiator control unit 202. The initiator control unit 202 stores in the buffer 210 the write data received from the host 500 via the initiator 300. The disk control unit 206 converts the write data stored in the buffer 210 to a predetermined data format. The disk control unit 206 then generates Error Correcting Code (ECC) and adds the ECC to the write data. The disk control unit 206 transmits the data added with the ECC to the head via the signal processing unit 108. The head writes the received write data into the magnetic disk 110 from the write head. Note that, in writing, the MPU 102 transmits a head alignment signal to the servo control unit 112. The servo control unit 112 causes the head actuator 114 to seek a track indicated by the received head alignment signal for track following control.

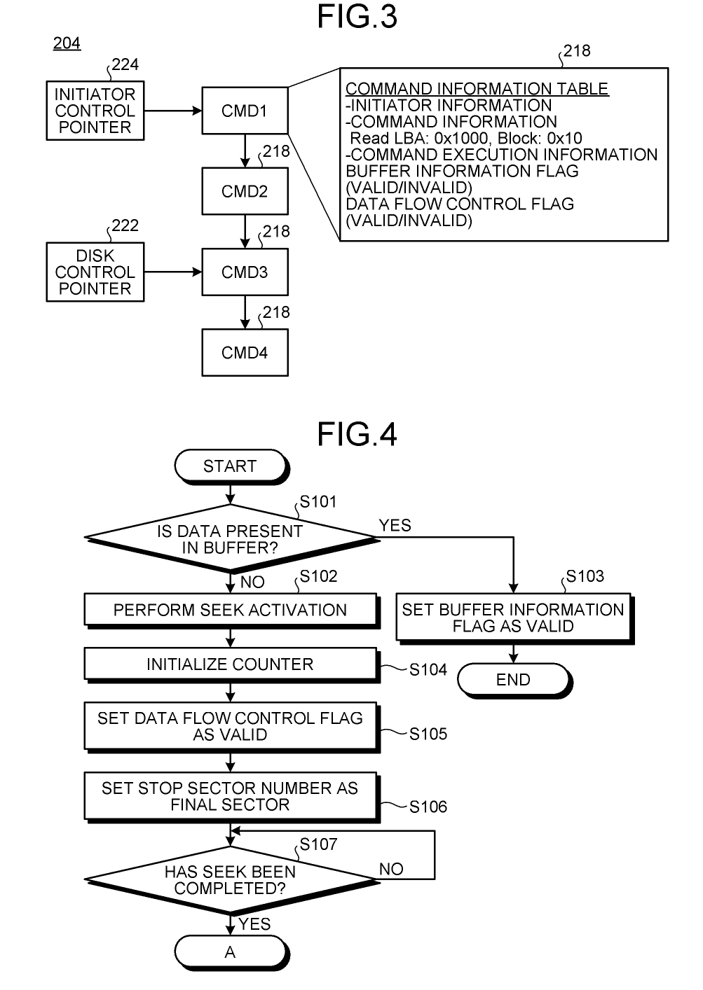

FIG. 3 depicts the command control unit 204. The command control unit 204 has stored therein a command received from the initiator control unit 202. FIG. 3 depicts a state where the command control unit 204 has the command information table 218 stored therein. The command information table 218 contains initiator information, command information, buffer information, and command execution information. The initiator information specifies an initiator that issued the command. The command information includes Logical Block Addressing (LBA), and is used to specify a sector of the magnetic disk 110. The command information includes information about the number of blocks of data to be read. The buffer information is used to specify a segment of the buffer 210 from which the data is to be read. The segment is obtained by dividing the buffer 210 into a predetermined number. The command execution information includes a buffer information flag and a data flow control flag. The buffer information flag indicates whether data is stored in the buffer 210. When the buffer information flag is set as valid, this means that data is stored in the buffer 210. On the other hand, when the buffer information flag is set as invalid, this means that no data is stored in the buffer 210. The data flow control flag indicates whether the data requested by the command has already been stored in the buffer 210. When the data flow control flag is set as valid, this means that the data requested by the command has not yet been stored in the buffer 210. On the other hand, when the data flow control flag is set as invalid, this means that the data requested by the command has already been stored in the buffer 210.

Upon receiving a command from the initiator 300, the initiator control unit 202 stores the command in the command control unit 204. Upon receiving the command, the command control unit 204 activates the initiator control unit 202 and the disk control unit 206. According to a process state of the disk control unit 206 and the initiator control unit 202, the command control unit 204 specifies a disk control pointer 222 and an initiator control pointer 224 to the command information table 218. The disk control unit 206 and the initiator control unit 202 refer to the disk control pointer 222 and the initiator control pointer 224 to execute a command. That is, the disk control unit 206 executes a command in the command information table 218 specified by the disk control pointer 222, whilst the initiator control unit 202 executes a command in the command information table 218 specified by the initiator control pointer 224. FIG. 3 depicts a state in which the disk control pointer 222 specifies the command information table 218 regarding a command 3, whilst the initiator control pointer 224 specifies the command information table 218 regarding a command 1. The disk control unit 206 refers to the command information table 218 regarding the command 3, whilst the initiator control unit 202 refers to the command information table 218 regarding the command 1 for executing a process.

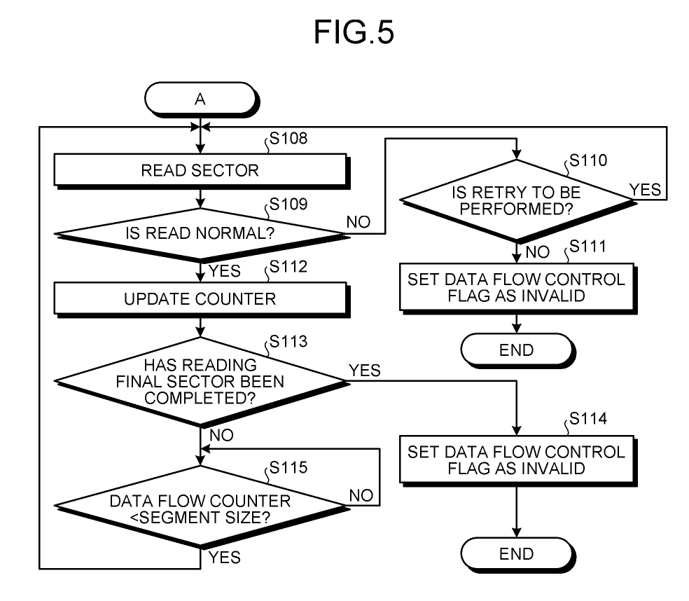

The data reading process is explained with reference to FIGS. 4 and 5. At Step S101, the disk control unit 206 refers to the buffer 210 to determine whether data requested by a command issued by the initiator 300 has been stored in the buffer 210. If the data requested by the command issued by the initiator 300 has been stored in the buffer 210, the process goes to Step S103. At Step S103, the disk control unit 206 sets the buffer information flag of the command information table 218 stored in the command control unit 204 as valid. The process then ends. On the other hand, if the data requested by the command issued by the initiator 300 has not been stored in the buffer 210, the process goes to Step S102.

At Step S102, the disk control unit 206 performs seek activation. Specifically, the disk control unit 206 refers to command information of the command information table 218 issued by the initiator 300 to control the servo control unit 112. The servo control unit 112 causes the head provided to the head actuator 114 to reach a target sector. The process then goes to Step S104.

At Step S104, the disk control unit 206 initializes a data flow counter 212. Specifically, the disk control unit 206 sets the value of the data flow counter 212 at “0”. The process then goes to Step S105.

At Step S105, the disk control unit 206 sets the data flow control flag of the command information table 218 stored in the command control unit 204 as valid. The process then goes to Step S106.

At Step S106, the disk control unit 206 refers to the command information of the command information table 218 stored in the command control unit 204 to obtain a sector number of a sector where data to be read is stored. Also, the disk control unit 206 specifies a sector near the sector where data to be read is stored as a sector from which pre-read data is to be read. From the sector number obtained from the command information table 218 and the sector from which pre-read data is to be read, the disk control unit 206 sets the value of a stop-sector-number storage unit 214 at a final sector number. The process then goes to Step S107.

At Step S107, from the value of the stop-sector-number storage unit 214 set at Step S106 and sector information obtained by the servo control unit 112, the disk control unit 206 determines whether seek has been completed. If seek has been completed, the process goes to Step S108. On the other hand, if seek has not been completed, the process returns to Step S107.

At Step S108, the disk control unit 206 causes the head of the head actuator 114 to perform read onto the target sector. The disk control unit 206 then stores the read data in the segment of the buffer 210 specified by the buffer control unit 208. The process then goes to Step S109.

At Step S109, the disk control unit 206 determines whether the data has been normally read. Specifically, the disk control unit 206 verifies validity of the data stored in the buffer 210 with ECC added to the data. When detecting an error from the data, the disk control unit 206 corrects the data if the error is correctable. Here, Cyclic Redundancy Check (CRC) may be added to the data as ECC. The process then goes to Step S112. On the other hand, when detecting an error from the data, if the error is correctable, the process goes to Step S110.

At Step S110, the disk control unit 206 determines whether a data read retry is to be performed. Whether to perform a retry can be determined by determining whether the number of times of reading exceeds an allowable number of times defined in advance. The allowable number of times is stored in advance in the disk control unit 206 from the host 500 through the initiator 300. The disk control unit 206 then compares the allowable number of times and the number of times of retry, and stops the data read retry when the number of times of retry exceeds the allowable number of times. When a data read retry is to be performed, the process returns to Step S108. On the other hand, when a data read retry is not to be performed, the process goes to Step S111.

At Step S111, the disk control unit 206 sets the data flow control flag of the command information table 218 stored in the command control unit 204 as invalid. The process then ends.

Next, a case is explained when it is determined at Step S109 that the data has been normally read and the process then goes to Step S112. At Step S112, the disk control unit 206 updates the data flow counter 212. Specifically, the disk control unit 206 increments the value of the data flow counter 212. The process then goes to Step S113.

At Step S113, from the command information of the command information table 218 stored in the command control unit 204 and the sector information obtained by the servo control unit 112, the disk control unit 206 determines whether the reading of the final sector has been completed. If reading of the final sector has been completed, the process goes to Step S114. At Step S114, the disk control unit 206 sets the data flow control flag of the command information table 218 stored in the command control unit 204 as invalid. The process then ends.

At Step S115, the disk control unit 206 determines whether the segment size is larger than the value of the data flow counter 212. The segment size represents an amount of data that can be stored in each segment of the buffer 210. When the segment size is larger than the value of the data flow counter 212, this means that the segment of the buffer 210 can further store data. On the other hand, when the segment size is equal to the value of the data flow counter 212, this means that data to be transferred to the initiator 300 has been overwritten. When the segment size is larger the value of the data flow counter 212, data is read from the next sector. Therefore, the process returns to Step S108, and the disk control unit 206 reads the target sector. On the other hand, when the segment size is equal to the value of the data flow counter 212, the process returns to Step S115 so as to wait until data stored in the buffer 210 is read and the segment can store new data.

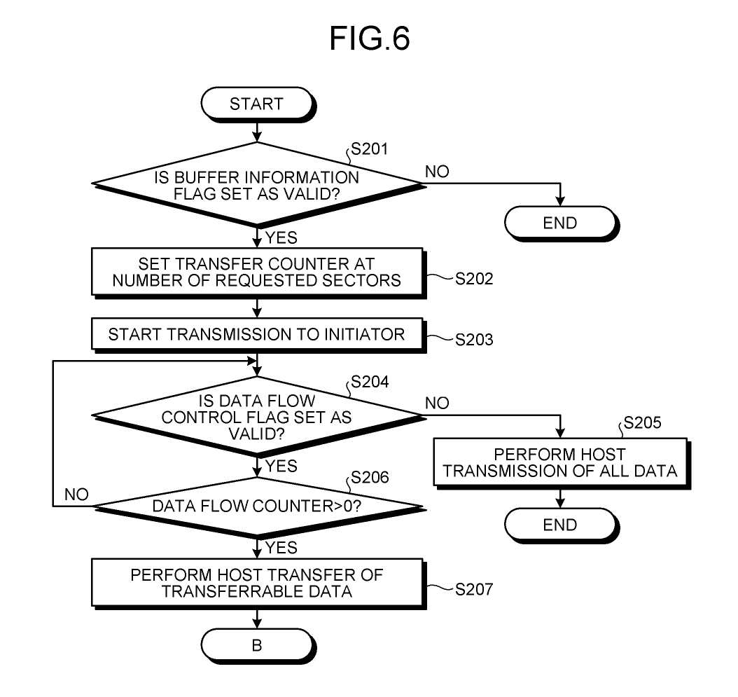

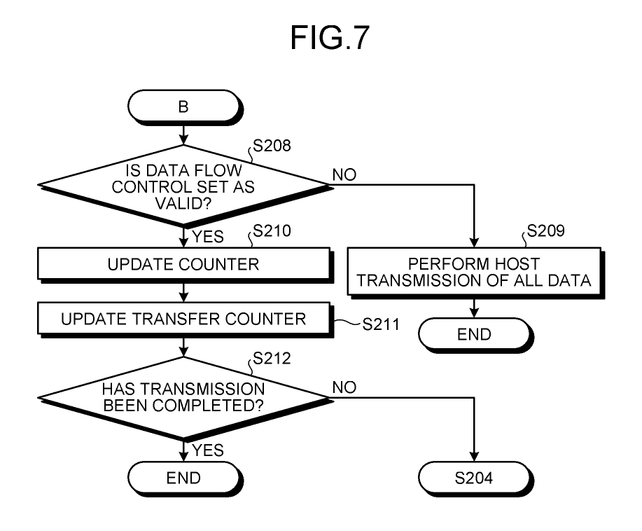

The data transmitting process is explained with reference to FIGS. 6 and 7. At Step S201, the initiator control unit 202 refers to the command information table 218 stored in the command control unit 204 to determine whether the buffer information flag is set as valid. When the buffer information flag is set as valid, the process goes to Step S202. On the other hand, when the buffer information flag is not valid, the command control unit 204 cannot activate the initiator control unit 202, and therefore the process ends.

At Step S202, the initiator control unit 202 sets the value of a transfer counter 216 at the number of pieces of data requested by the command issued from the initiator 300. The process then goes to Step S203.

At Step S203, the initiator control unit 202 starts data transmission to the initiator 300. The process then goes to Step S204.

At Step S204, the initiator control unit 202 determines whether the data flow control flag of the command information table 218 stored in the command control unit 204 is set as invalid. When the data flow control flag is set as invalid, the process goes to Step S205. At Step S205, since the data to be transmitted to the initiator 300 is stored in the buffer 210, the initiator control unit 202 performs transmission of that data to the initiator 300. The process then ends. Even without referring to the data flow counter 212, the initiator control unit 202 can determine that the data to be transmitted has already been stored in the buffer 210 because the data flow control flag is set as invalid. Therefore, the disk control unit 206 can use the data flow counter 212 for reading data requested by a new command. For this reason, while the initiator control unit 202 is transmitting data to the initiator 300, the disk control unit 206 can read the data requested by a new command. On the other hand, when the data flow control flag is set as valid, the process goes to Step S206.

At Step S206, the initiator control unit 202 refers to the data flow counter 212 to determine whether the value of the data flow counter 212 is larger than 0. When the value of the data flow counter 212 is larger than 0, this means that data has been read by the disk control unit 206 and has been stored in the buffer 210 by the buffer control unit 208. By referring to the value of the data flow counter 212, the initiator control unit 202 can determine whether the data has been stored in the buffer 210. When the value of the data flow counter 212 is larger than 0, the process goes to Step S207. On the other hand, when the value of the data flow counter 212 is 0, the process returns to Step S204.

At Step S207, the initiator control unit 202 transmits the data stored in the buffer 210 to the initiator 300. The process then goes to Step S208.

At Step S208, the initiator control unit 202 refers to the command information table 218 to determine whether data flow control is set as valid. When data flow control is set as valid, the process goes to Step S210. On the other hand, when the data flow control is set as invalid, the process goes to Step S209. At Step S209, since the data to be transmitted to the initiator 300 is stored in the buffer 210, the initiator control unit 202 transmits the data to the initiator 300. The process then ends.

At Step S210, the initiator control unit 202 updates the data flow counter 212. Specifically, the initiator control unit 202 decrements the value of the data flow counter 212. The process then goes to Step S211.

At Step S211, the initiator control unit 202 updates the transfer counter 216. Specifically, the initiator control unit 202 decrements the value of the transfer counter 216. When the value of the transfer counter 216 becomes 0, the initiator control unit 202 determines that the transmission of the data to the initiator 300 has been completed. The process then goes to Step S212.

At Step S212, the initiator control unit 202 determines whether the transmission of the data requested by the command to the initiator 300 has been completed. If the transmission of the data to the initiator 300 has been completed, the process ends. On the other hand, if the transmission of the data to the initiator 300 has not been completed, the process returns to Step S204.

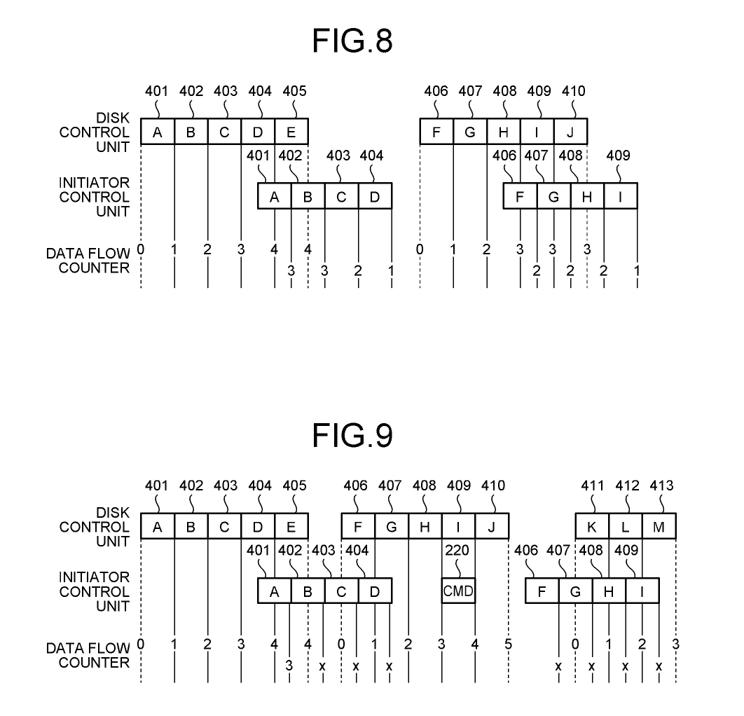

Finally, the effectiveness of the present embodiment is explained. FIG. 8 depicts data processing of the magnetic disk device 100 configured in a manner such that the command does not include a data flow control flag in the command information table 218. An upper portion of FIG. 8 depicts a reading process of the magnetic disk device 100, a middle portion thereof depicts a transmitting process of the magnetic disk device 100, and a lower portion thereof depicts values of the counter.

Upon storing read data A (401) in the buffer, the magnetic disk device 100 increments the counter to set the value of the counter at “1”. Next, upon storing read data B (402) in the buffer, the magnetic disk device 100 increments the counter to set the value of the counter at “2”. Then, upon storing read data C (403) in the buffer, the magnetic disk device 100 increments the counter to set the value of the counter at “3”. Furthermore, upon storing read data D (404) in the buffer, the magnetic disk device 100 increments the counter to set the value of the counter at “4”. Upon transmitting the data A (401) stored in the buffer to the host, the magnetic disk device 100 decrements the counter to set the value of the counter at “3”. Finally, upon storing read pre-read data E (405) in the buffer, the magnetic disk device 100 increments the counter to set the value of the counter at “4”. The pre-read data is data not requested by the command but read in advance and stored in the buffer. With the pre-read data being stored in the buffer, when a new command requests the pre-read data, the reading process can be efficiently performed because the pre-read data has already been stored in the buffer. Upon transmitting the data B (402) stored in the buffer to the host, the magnetic disk device 100 decrements the counter to set the value of the counter at “3”. Upon transmitting the data C (403) stored in the buffer to the host, the magnetic disk device 100 decrements the counter to set the value of the counter at “2”. Finally, upon transmitting the data D (404) stored in the buffer to the host, the magnetic disk device 100 decrements the counter to set the value of the counter at “1”. Upon completion of the data transmission to the host, the magnetic disk device 100 can now start reading the data indicated by the next command.

Thereafter, in a manner as explained above, the magnetic disk device 100 reads data F (406), data G (407), data H (408), data I (409), and pre-read data J (410), and then stores these pieces of data in the buffer. The magnetic disk device 100 then refers to the data flow counter 212 to transmit the data F (406), the data G (407), the data H (408), and the data I (409) to the host.

FIG. 9 depicts the reading process of the magnetic disk device 100 in the present embodiment. Before performing the reading process, the command information table 218 has ten commands stored therein. For example, every time the disk control unit 206 completes one command, the initiator control unit 202 receives a new command from the initiator 300, and then stores the new command in the command information table 218. An upper portion of FIG. 9 depicts a process of the disk control unit 206, a middle portion thereof depicts a process of the initiator control unit 202, and a lower portion thereof depicts values of the data flow counter 212.

Upon storing data A (401) read from the magnetic disk 110 in the buffer 210, the disk control unit 206 increments the data flow counter 212 to set the value of the data flow counter 212 at “1”. Next, upon storing data B (402) read from the magnetic disk 110 in the buffer 210, the disk control unit 206 increments the data flow counter 212 to set the value of the data flow counter 212 at “2”. Then, upon storing data C (403) read from the magnetic disk 110 in the buffer 210, the disk control unit 206 increments the data flow counter 212 to set the value of the data flow counter 212 at “3”. Furthermore, upon storing data D (404) read from the magnetic disk 110 in the buffer 210, the disk control unit 206 increments the data flow counter 212 to set the value of the data flow counter 212 at “4”. Upon transmitting the data A (401) stored in the buffer to the host 500, the initiator control unit 202 decrements the data flow counter 212 to set the value of the data flow counter 212 at “3”. Finally, upon storing the pre-read data E (405) read from the magnetic disk 110 in the buffer 210, the disk control unit 206 increments the data flow counter 212 to set the value of the data flow counter 212 at “4”. Here, since all pieces of data indicated by the command have been stored in the buffer 210, the disk control unit 206 sets the data flow control flag of the command information table 218 as invalid.

Since the data flow control flag is set as invalid, the initiator control unit 202 can determine that the data B (402), the data C (403), and the data D (404) are stored in the buffer 210. Thus, without referring to the data flow counter 212, the initiator control unit 202 can transmit the data B (402), the data C (403), and the data D (404) to the host 500. Since the disk control unit 206 has completed one command, the initiator control unit 202 receives a new command from the initiator 300, and then stores the new command in the command information table 218. Since the initiator control unit 202 does not refer to the data flow counter 212, the disk control unit 206 initializes the data flow counter 212, and can start reading of data indicated by the new command. As depicted in FIG. 9, while the initiator control unit 202 is transmitting the data C (403) and the data D (404) to the host 500, the disk control unit 206 can read the data F (406).

Thereafter, in a manner as explained above, the disk control unit 206 reads data G (407), data H (408), data I (409), and pre-read data J (410) from the magnetic disc 110, and then stores these pieces of data in the buffer 210. Upon storing the pre-read data J (410) in the buffer 210, the disk control unit 206 sets the data flow control flag as invalid. Therefore, the initiator control unit 202 refers to the flag to transmit the data F (406), the data G (407), the data H (408), and the data I (409) to the host 500. As depicted in FIG. 9, while the initiator control unit 202 is transmitting the data G (407), the data H (408), and the data I (409) to the host 500, the disk control unit 206 can read data K (411), data L (412), and data M (413).

The method for controlling a storage device described above may be provided as a computer readable storage medium containing instructions that, when executed by a computer, cause the computer to perform the method. The computer readable storage medium includes a CD-ROM, DVD-ROM, IC memory, and the like.

According to the present invention, the counter can be used for processing data read upon a new instruction without waiting until data transmission to the processing device is completed. Thus, an increase in data processing speed can be achieved without increasing the amount of hardware configuration.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A storage device including a first storage unit that stores data read from a recording medium based on an instruction received from a processing device, and transmitting the data stored in the first storage unit to the processing device, the storage device comprising:
a second storage unit that stores the instruction received from the processing device;
a counter that counts the number of pieces of data stored in the first storage unit; and
a control unit that transmits the data stored in the first storage unit to the processing device based on a count value of the counter and, when the data read upon the instruction is stored in the first storage unit, writes identification information indicating that storing data has been completed in the second storage unit and, based on the identification information, transmits the data stored in the first storage unit to the processing device.

2. The storage device according to claim 1, wherein
upon writing the identification information in the second storage unit, the control unit starts reading new data from the recording medium based on a new instruction received from the processing device.

3. The storage device according to claim 2, wherein
while transmitting the data stored in the first storage unit to the processing device, the control unit reads new data from the recording medium based on the new instruction.

4. The storage device according to claim 1, wherein
upon writing the identification information in the second storage unit, the control unit initializes a counter value of the counter.

5. A method for controlling a storage device that stores data read from a recording medium based on a received instruction and transmits the stored data, the method comprising:
storing the instruction;
counting the number of pieces of data stored;
transmitting the stored data based on the counted number; and
writing identification information indicating that storing the data has been completed when the storing the data read upon the instruction has been completed, and transmitting the stored data based on the identification information.

6. The method according to claim 5, wherein
when the identification information is written, reading new data from the recording medium is started based on a received new instruction.

7. The method according to claim 6, wherein
while the stored data is being transmitted, new data is read from the recording medium based on the new instruction.

8. The method according to claim 5, wherein
when the identification information is written, the counted value is initialized.

9. A computer readable storage medium containing instructions for controlling a storage device that stores data read from a recording medium based on a received instruction and transmits the stored data, wherein the instructions, when executed by a computer, cause the computer to perform:
storing the instruction;
counting the number of pieces of data stored;
transmitting the stored data based on the counted number; and
writing identification information indicating that storing the data has been completed when the storing the data read upon the instruction has been completed, and transmitting the stored data based on the identification information.

10. The computer readable storage medium according to claim 9, wherein
when the identification information is written, reading new data from the recording medium is started based on a received new instruction.
